(19) United States
(12) Patent Application Publication
(10) Pub. No.: US 2025/0272843 A1
(43) Pub. Date: Aug. 28, 2025

(54) ELECTRONIC DEVICE AND METHOD FOR ADJUSTING DISPLAY REGION BASED ON MOTION

(71) Applicant: Wistron Corporation, New Taipei City (TW)

(72) Inventors: Hao Chen Weng, New Taipei City (TW); Hong-Ting Cheng, New Taipei City (TW); Ping Che Yu, New Taipei City (TW)

(73) Assignee: Wistron Corporation, New Taipei City (TW)

(21) Appl. No.: 18/642,783

(22) Filed: Apr. 22, 2024

(30) Foreign Application Priority Data
Feb. 27, 2024 (TW) 113107047

(51) Int. Cl. G06T 7/11; G06T 3/40; G06T 7/20; G06V 40/16; G10L 15/26

(52) U.S. Cl. CPC G06T 7/11; G06T 3/40; G06T 7/20; G06V 40/172; G10L 15/26

(57) ABSTRACT

An electronic device and a method for adjusting a display region based on motion are disclosed. The method includes: obtaining a first image including a first target object; detecting the first image to obtain a joint of the first target object; calculating a first score according to a first displacement of the first joint; in response to the first score being greater than a threshold, generating an adjustment command for adjusting a first display region of the first image according to the first joint; and outputting the adjustment command.

### CROSS-REFERENCE TO RELATED APPLICATION

This application claims the priority benefit of Taiwan application serial no. 113107047, filed on Feb. 27, 2024. The entirety of the above-mentioned patent application is hereby incorporated by reference herein and made a part of this specification.

### BACKGROUND

### Technical Field

This disclosure relates to an image processing technology, and in particular to an electronic device and a method for adjusting a display region based on motion.

### Description of Related Art

Currently, there are many fitness apps that provide demonstration videos for users. Users can use their cell phones to play the demonstration videos and follow the movements of the trainers in the demonstration videos. However, the small screen size of a cell phone often prevents the user from seeing clearly the movements demonstrated by the trainers in the video. Although users can zoom in on localized images by operating the phone, frequent operation of the phone may affect exercise experience of the user.

### SUMMARY

The disclosure provides an electronic device and a method for adjusting a display region based on motion, capable of automatically adjusting a display region of a played image.

The electronic device for adjusting the display region based on motion of the disclosure includes a processor and a transceiver. The transceiver obtains a first image including a first target object. The processor is coupled to the transceiver and configured to: detect the first image to obtain a first joint of the first target object; calculate a first score according to a first displacement of the first joint; in response to the first score being greater than a threshold, generate an adjustment command for adjusting a first display region of the first image according to the first joint; and output the adjustment command through the transceiver.

In an embodiment of the disclosure, the processor is further configured to: calculate a second score according to a second displacement of a second joint of the first target object; and in response to the second score being greater than the threshold, generate the adjustment command according to the first joint and the second joint.

In an embodiment of the disclosure, the processor is further configured to: divide a region of interest of the first image to obtain multiple sub-regions, in which the sub-regions include a first sub-region and a second sub-region; determine that the first joint is located in the first sub-region and the second joint is located in the second sub-region according to the first image; and in response to the second sub-region being adjacent to the first sub-region, generate the adjustment command according to the first joint and the second joint.

In an embodiment of the disclosure, the sub-regions include a third sub-region corresponding to a third joint of the first target object, in which a third score corresponding to the third joint is greater than the threshold, and the processor is further configured to: in response to the first sub-region being adjacent to the second sub-region and the third sub-region being adjacent to at least one of the first sub-region and the second sub-region, generate the adjustment command according to the first joint, the second joint, and the third joint.

In an embodiment of the disclosure, the processor is further configured to: generate the first display region according to at least one sub-region including the first sub-region; and in response to the second sub-region not being adjacent to the at least one sub-region, generate a second display region of the first image according to the second sub-region.

In an embodiment of the disclosure, the adjustment command instructs that the first display region of the first image is output in a first period and the second display region of the first image is output in a second period.

In an embodiment of the disclosure, the processor is further configured to: in response to a size of the second display region being different from a size of the first display region, generate the adjustment command including a zoom in operation or a zoom out operation.

In an embodiment of the disclosure, the processor is further configured to: determine a boundary of the first display region according to a union of the first sub-region and the second sub-region.

In an embodiment of the disclosure, the processor is further configured to: obtain a first audio file corresponding to the first image through the transceiver; determine a first correlation between the first audio file and the first joint; and calculate the first score according to the first displacement and the first correlation.

In an embodiment of the disclosure, the processor is further configured to: perform a speech-to-text conversion on the first audio file to generate text; determine a number of words in the text associated with the first joint; and determine the first correlation according to the number of the words.

In an embodiment of the disclosure, the processor is further configured to: determine a first weight of the first displacement and a second weight of the first correlation according to a category of the first image; and calculate the first score according to the first displacement, the first weight, the first correlation, and the second weight.

In an embodiment of the disclosure, the processor is further configured to perform: obtain a second image including a second target object according to the transceiver; and generate a playback control command for the first image according to the second image, and output the playback control command through the transceiver.

In an embodiment of the disclosure, the processor is further configured to: detect the second image to obtain multiple limb joints of the second target object, in which the limb joints include a left elbow joint, a right elbow joint, a left knee joint, and a right knee joint; calculate an angle according to the limb joints, and determine that the angle is within a default range; and in response to the angle being outside the default range, generate the playback control command for pausing the first image.

In an embodiment of the disclosure, the processor is further configured to: perform facial recognition on a second target object in a second image to obtain multiple joints; calculate an area change of a polygon formed by the joints; and in response to an absolute value of the area change being greater than a change threshold, generate a playback control command for playback speed control.

In an embodiment of the disclosure, the playback control command is used to reduce a playback speed of the first image.

In an embodiment of the disclosure, the processor is further configured to: perform facial recognition on a second target object in a second image to obtain multiple joints; calculate an area change of a polygon formed by the joints; and generate a playback control command for playback speed control according to the area change.

In an embodiment of the disclosure, the processor is further configured to: in response to the area change being greater than a first threshold, generate the playback control command for reducing a playback speed of the first image; and in response to the area change being less than or equal to a second threshold, generate the playback control command for increasing the playback speed of the first image.

In an embodiment of the disclosure, the processor is further configured to: detect the first image to obtain a center point and a height of the first target object; and determine a region of interest of the first image according to the center point and the height.

In an embodiment of the disclosure, the processor is further configured to: output a script through the transceiver, in which the script includes the adjustment command and a timestamp of the first image corresponding to the adjustment command.

The method for adjusting a display region based on motion of the disclosure includes the following. A first image including a first target object is obtained. The first image is detected to obtain a first joint of the first target object. A first score is calculated according to a first displacement of the first joint. In response to the first score being greater than a threshold, an adjustment command for adjusting a first display region of the first image is generated according to the first joint. The adjustment command is output.

Based on the above, the electronic device of the disclosure may adjust the display region of the image according to the motion of the person in the image, so that the local details of the image may be more clearly presented to the user.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate example embodiments of the disclosure and, together with the description, serve to explain the principles of the disclosure.

FIG. 1 illustrates a schematic diagram of an electronic device for adjusting a display region based on motion, according to an embodiment of the disclosure.

FIG. 2 illustrates a schematic diagram of script generation and application according to an embodiment of the disclosure.

FIG. 3 illustrates a schematic diagram of a region of interest of a demonstration image according to an embodiment of the disclosure.

FIG. 4 illustrates a schematic diagram of adjustment of a display region according to an embodiment of the disclosure.

FIG. 5 illustrates a schematic diagram of adjustment of a display region according to an embodiment of the disclosure.

FIG. 6 illustrates a schematic diagram of a target object according to an embodiment of the disclosure.

FIG. 7 illustrates a flow chart of a method for adjusting a display region based on motion according to an embodiment of the disclosure.

### DESCRIPTION OF THE EMBODIMENTS

When a user is watching a demonstration image of a trainer for exercise, if the user cannot see the local details of the demonstration image clearly, the user has to manually operate a terminal device to adjust a display region of the demonstration image. The exercise experience of the user will be affected as a result. In order to solve the above problem, the disclosure provides a method for automatically adjusting the display region of an image.

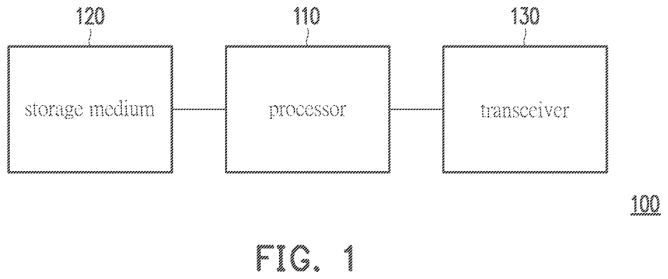

FIG. 1 illustrates a schematic diagram of an electronic device 100 for adjusting a display region based on motion, according to an embodiment of the disclosure. The electronic device 100 may include a processor 110, a storage medium 120, and a transceiver 130.

The processor 110 is, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA), or other similar components or a combination of the above components. The processor 110 may be coupled to the storage medium 120 and the transceiver 130, and access and execute multiple modules and various applications stored in the storage medium 120.

The storage medium 120 is, for example, any type of fixed or removable random access memory (RAM), read-only memory (ROM), or flash memory, hard disk drive (HDD), solid state drive (SSD), or similar components or a combination of the above components, configured to store multiple modules or various applications that can be executed by the processor 110.

The transceiver 130 transmits or receives signals in a wireless or wired manner. The transceiver 130 may also perform, for example, low noise amplification, impedance matching, mixing, up or down frequency conversion, filtering, amplification, and similar operations. The processor 110 may be communicatively connected to an external electronic device through the transceiver 130.

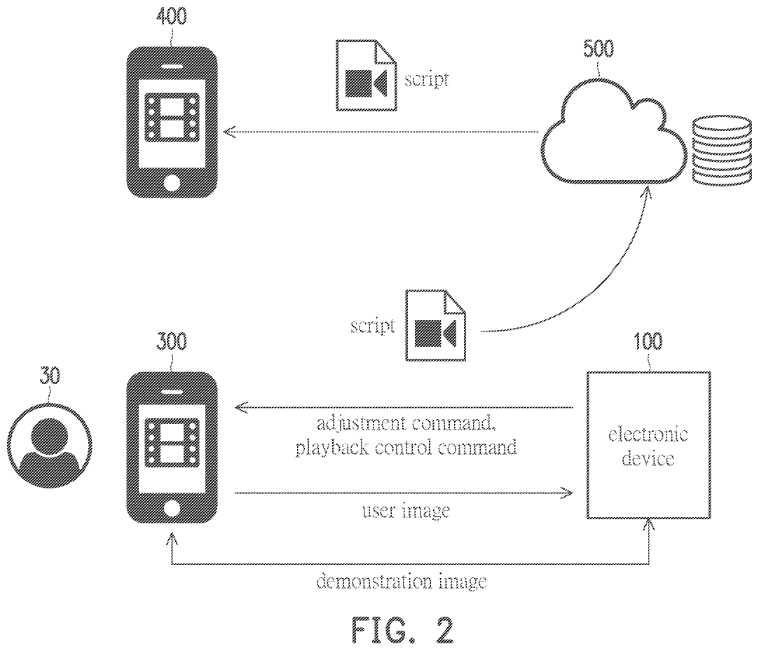

FIG. 2 illustrates a schematic diagram of script generation and application according to an embodiment of the disclosure. The electronic device 100 may be communicatively connected to a cloud server 500 and one or more terminal devices (e.g., a terminal device 300 or a terminal device 400) through the transceiver 130.

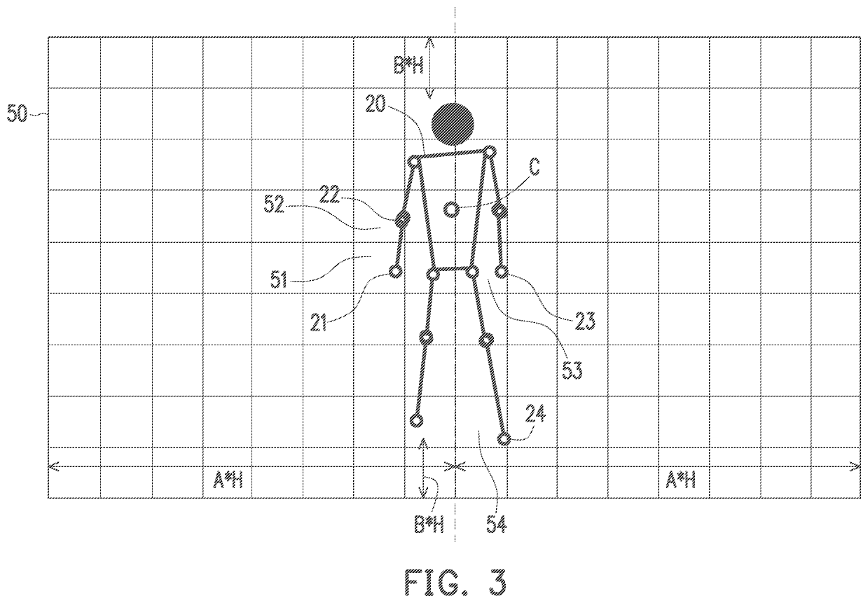

The user may operate the terminal device 300 to play a demonstration image including a target object 20 (as shown in FIG. 3), where the target object 20 is, for example, a trainer who instructs the user how to exercise. In addition, the terminal device 300 may capture a user image including a target object 30, where the target object 30 is, for example, a user who are exercising (i.e., the owner of the terminal device 300). The terminal device 300 may transmit the user image to the electronic device 100.

The electronic device 100 may receive a demonstration image including the target object 20 (e.g., a trainer) through the transceiver 130 (e.g., download a demonstration image from the Internet, such as an aerobic dance demonstration video or a yoga instructional video), or receive a user image including the target object 30 (e.g., the user). The electronic device 100 may generate an adjustment command according to the demonstration image, or may generate a playback control command according to the user image. The electronic device 100 may transmit the adjustment command or the playback control command to the terminal device 300 through the transceiver 130. The terminal device 300 may adjust the display region of the demonstration image according to the adjustment command, or may control the playback of the demonstration image according to the playback control command.

In an embodiment, the adjustment command may include, but is not limited to, a zoom in command, a zoom out command, or a pan command.

In an embodiment, the playback control command may include, but is not limited to a fast forward command, a rewind command, a slow-motion command, a pause command, or a (resume) play command.

FIG. 3 illustrates a schematic diagram of a region of interest 50 of a demonstration image according to an embodiment of the disclosure. After receiving the demonstration image including the target object 20 (e.g., the trainer), the processor 110 may perform object detection to detect the demonstration image, and then obtain a center point C and a height H of the target object 20 (e.g., the trainer). The processor 110 may determine the region of interest 50 of the demonstration image according to the center point C and the height H of the target object 20 (e.g., the trainer). For example, a shortest distance between an upper boundary (or a lower boundary) of the region of interest 50 and the target object 20 (e.g., the trainer) may be B*H, where B may be a default weight. A distance between a left boundary (or a right boundary) of the region of interest 50 and the center point C may be A*H, where A may be a default weight.

The processor 110 may perform the object detection to detect the region of interest 50 of the demonstration image, and then obtain one or more joints of the target object 20 (e.g., the trainer). For example, the processor 110 may obtain a joint 21 corresponding to the right palm of the target object 20 (e.g., the trainer), a joint 22 corresponding to the right elbow of the target object 20 (e.g., the trainer), a joint 23 corresponding to the left palm of the target object 20 (e.g., the trainer), or a joint 24 corresponding to the left foot of the target object 20 (e.g., the trainer). It should be noted that the target object 20 (e.g., the trainer) may have one or more joints that are not shown in FIG. 3 to FIG. 5.

The processor 110 may calculate a score corresponding to the joint according to a displacement of the joint. In an embodiment, the displacement of a joint may be proportional to the score of the joint. That is, joints with larger displacement may have higher scores.

In an embodiment, the score of the joint may be associated with an audio file synchronized with the demonstration image. The processor 110 may obtain the audio file synchronized with the demonstration image through the transceiver 130. The processor 110 may determine a correlation between the audio file and the joint, and may calculate the score of the joint according to the displacement of the joint and the correlation of the joint. Specifically, the processor 110 may perform a speech-to-text (STT) conversion on the audio file to generate text. Next, the processor 110 may determine a number of words in the text associated with the joint, and further determine the correlation between the joint and the audio file according to the number of associated words. For example, if the trainer in the demonstration video keeps repeating the instruction to “turn your right palm”, the processor 110 may determine that the audio file is highly relevant to the joint 21 according to the multiple occurrences of the word “right palm” in the text of the audio file.

In an embodiment, the storage medium 120 may pre-store a lookup table, in which the lookup table may include mapping relationships between one or more words and default words. Assuming that multiple words having the mapping relationship to the default word appear in the text in the audio file, the processor 110 may determine the correlation between the joint and the audio file according to the number of the words. For example, the lookup table may record the mapping relationship between words such as “buttocks”, “tailbone” or “ischium” and the default word “hip”. If the text in the audio file appears once for “tailbone” once and twice for “ischium”, the processor 110 may determine the correlation between the audio file and the joint corresponding to “buttocks” according to the number “3”.

In calculating the score of a joint according to the displacement and correlation of the joint, the displacement and correlation may have their respective weights. The processor 110 may calculate the score of the joint according to the displacement, the weight of the displacement, the correlation, and the weight of the correlation. In an embodiment, the processor 110 may determine the weight of the displacement or the weight of the correlation according to a category of the demonstration image. For example, if the theme of the demonstration image is fitness instruction, the trainer may often give instructions to the user in audio in the demonstration image. Accordingly, the processor 110 may increase the weight of the correlation of the joint and reduce the weight of the displacement of the joint to enhance the impact of the audio file on the score calculation of the joint.

The processor 110 may determine whether the joint can be used to generate an adjustment command for the display region of the demonstration image according to the score of the joint. If the score corresponding to the joint is greater than a threshold, the processor 110 may determine that the joint can be used to generate the adjustment command. If the score corresponding to the joint is less than or equal to the threshold, the processor 110 may determine that the joint cannot be used to generate the adjustment command. For example, if the score of the joint 21 is greater than the threshold and the score of the joint 22 is less than or equal to the threshold, the processor 110 may generate the adjustment command according to the joint 21 rather than the joint 22. As another example, if the score of the joint 21 is greater than the threshold and the score of the joint 22 is also greater than the threshold, the processor 110 may generate the adjustment command according to the joint 21 and the joint 22.

The processor 110 may divide the region of interest 50 of the demonstration image to obtain multiple sub-regions (e.g., grids), and may determine the sub-regions where each joint is currently located. For example, the processor 110 may determine that the joint 21 is located in a sub-region 51, the joint 22 is located in a sub-region 52, the joint 23 is located in a sub-region 53, or the joint 24 is located in the sub-region 54. In the following, the sub-region where the joint with score greater than the threshold is located is called a selected sub-region.

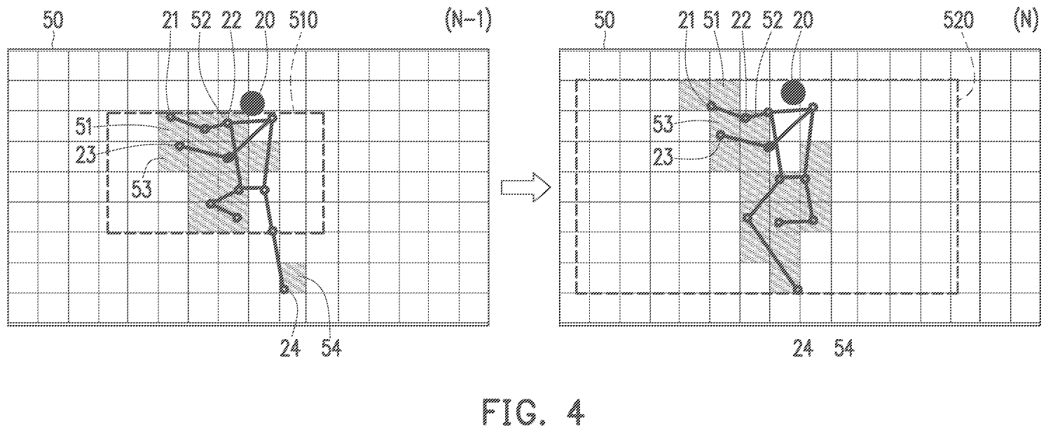

FIG. 4 illustrates a schematic diagram of adjustment of a display region according to an embodiment of the disclosure. The processor 110 may generate a corresponding display region according to the selected sub-regions adjacent to each other. If multiple selected sub-regions are used to generate an adjustment command for a display region, one of the selected sub-regions shall be adjacent to one or more other sub-regions of the selected sub-regions. For example, assuming that the sub-regions 51, 52, 53, and 54 are all selected sub-regions, the processor 110 may determine that the sub-region 51 and the sub-region 52 may be used to generate an adjustment command for a display region 510 based on the sub-region 52 being adjacent to the sub-region 51, where the display region 510 corresponds to a timestamp (N−1). In addition, the processor 110 may determine that the sub-region 53 can also be used to generate an adjustment command for the display region 510 based on the sub-region 53 being adjacent to the sub-region 51. Since the sub-region 54 is not adjacent to any of the sub-regions 51, 52, or 53, the processor 110 may determine that the sub-region 54 is not available for generating an adjustment command for the display region 510.

In an embodiment, if the selected sub-regions correspond to the display region, the processor 110 may determine a boundary of the display region according to a union of the selected sub-regions. For example, the processor 110 may determine the boundary of the display region 510 according to the union of the selected sub-regions including the sub-regions 51, 52, and 53. Since the sub-region 51 or the sub-region 52 is located at the upper boundary of the union, the processor 110 may determine the upper boundary of the display region 510 according to the sub-region 51 or the sub-region 52.

When the timestamp of the demonstration image advances from (N−1) to (N), the processor 110 may generate a new display region 520 for the demonstration image corresponding to the timestamp (N). The selected sub-regions corresponding to the display region 520 include, for example, the sub-regions 51, 52, 53, and 54. The processor 110 may generate an adjustment command according to the display region 510 corresponding to the timestamp (N−1) and the display region 520 corresponding to the timestamp (N). For example, the processor 110 may generate a reduction command based on a size of the display region 520 being larger than a size of the display region 510, so that a display of the terminal device 300 may completely display the entire display region 520. In addition, the processor 110 may generate a pan command based on a center point of the display region 520 being different from a center point of the display region 510.

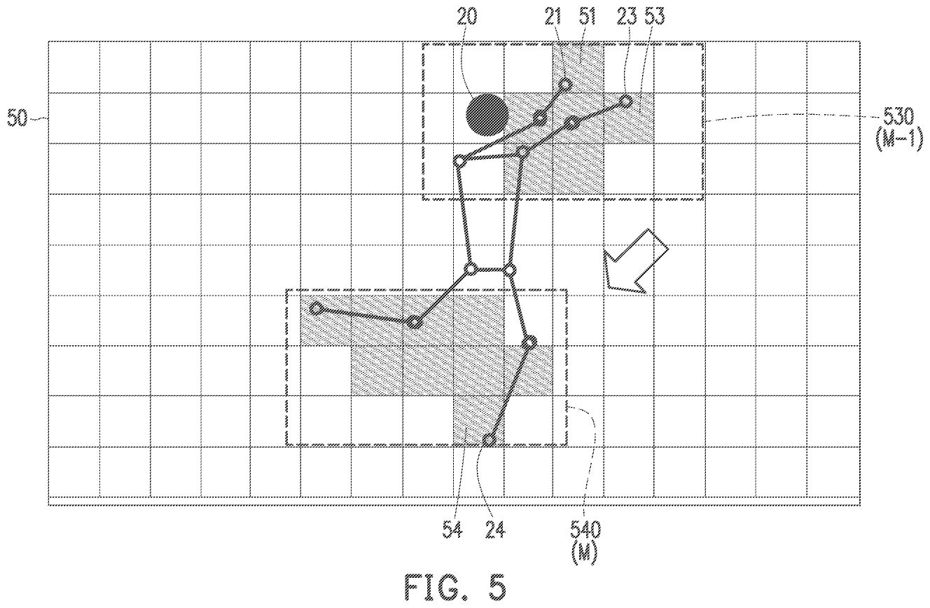

The processor 110 may generate multiple display regions of the demonstration image within the same period, and the selected sub-region of one display region is not adjacent to the selected sub-region of another display region. FIG. 5 illustrates a schematic diagram of adjustment of a display region according to an embodiment of the disclosure. The processor 110 may generate a display region 530 based on multiple selected sub-regions including the sub-regions 51, 52, and 53, and may generate a display region 540 based on multiple selected sub-regions including the sub-region 54, in which the selected sub-region (e.g., the sub-region 54) of the display region 540 is not adjacent to the selected sub-region (e.g., the sub-region 51, 52, or 53) of display region 540.

The processor 110 may generate an adjustment command according to multiple display regions of the demonstration image. The adjustment command may be used to instruct a terminal device (e.g., the terminal device 300) to output different display regions at different time periods. For example, the adjustment command may instruct the terminal device 300 to output the image in the display region 530 during a period (M−1), and to output the image in the display region 540 during a period (M).

In an embodiment, the processor 110 may generate a pan command based on the display regions of the demonstration image having different center points. For example, the processor 110 may generate a pan command based on a center point of the display region 540 being different from a center point of the display region 530. The terminal device 300 may pan the output image from the display region 530 to the display region 540 according to the pan command.

In an embodiment, the processor 110 may generate an adjustment command for a zoom in operation or a zoom out operation based on the display regions of the demonstration image having different sizes. For example, the processor 110 may generate a zoom out command based on a size of the display region 540 being larger than a size of the display region 530. The terminal device 300 may perform a zoom out operation on the output image according to the zoom out command. Accordingly, the user may view a smaller portion of the demonstration image (with clearer details or higher resolution) at the period (M−1) and a larger portion of the demonstration image (with less clear details or lower resolution) at the period (M).

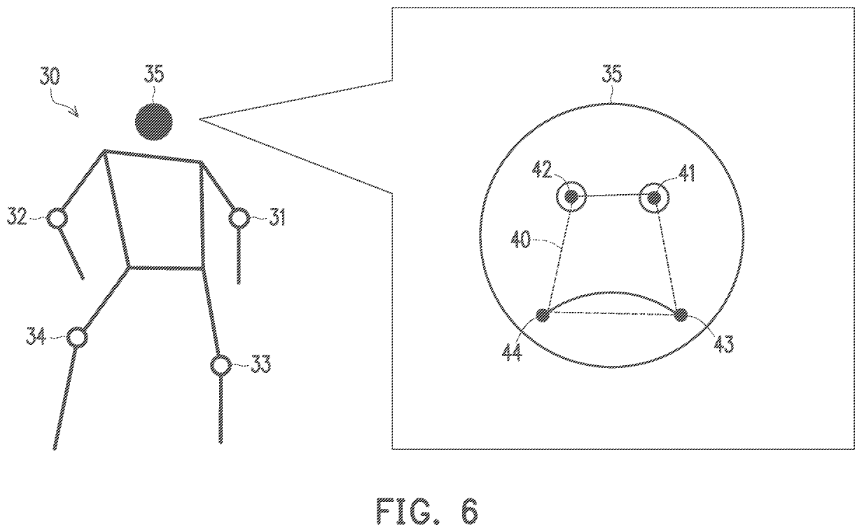

The processor 110 may generate a playback control command according to the user image including the target object 30 (i.e., the user of the terminal device 300). FIG. 6 illustrates a schematic diagram of a target object 30 (e.g., the user) according to an embodiment of the disclosure. In an embodiment, the processor 110 may determine whether the target object 30 (e.g., the user) is still watching the terminal device 300 or has moved away from the terminal device 300 according to the user image, and then determines whether to instruct the terminal device 300 to pause playing the demonstration image. Specifically, the processor 110 may perform object detection on the user image to obtain multiple limb joints of the target object 30 (e.g., the user), in which the limb joints may include a joint 31 representing the left elbow, a joint 32 representing the right elbow, the joint 33 representing the left knee, and the joint 34 representing the right knee. The processor 110 may calculate an angle according to multiple limb joints and determine whether the angle is within a default range. If the angle is within the default range, the processor 110 may determine that the target object 30 (e.g., the user) is still in front of the terminal device 300 (i.e., the target object 30 still appears in the user image captured by the terminal device 300). Accordingly, the processor 110 may not instruct the terminal device 300 to pause playing the demonstration image. If the angle is outside the default range, the processor 110 may determine that the target object 30 has moved away from the terminal device 300 (i.e., the target object 30 does not appear in the user image captured by the terminal device 300). Accordingly, the processor 110 may generate a pause command, in which the pause command may instruct the terminal device 300 to pause playing the demonstration image. The processor 110 may calculate an angle θ_{hand} and an angle θ_{leg} according to formula (1) and the formula (2), and may determine whether the angle θ_{hand} or the angle θ_{leg} is outside the default range according to formula (3), where (x₁, y₁) are the coordinates of the joint 31, (x₂, y₂) are the coordinates of the joint 32, (x₃, y₃) are the coordinates of the joint 33, and (x₄, y₄) are the coordinates of the joint 34. If formula (3) does not hold, the processor 110 may generate a suspend command. The default range of 10 to 180 degrees in formula (3) is determined based on multiple image samples of limb joints of different people, for example.

$${θ}_{hand} = {cos}^{- 1} ( \frac{( {x}_{2} - {x}_{1} ) \cdot ( {x}_{4} - {x}_{3} ) + ( {y}_{2} - {y}_{1} ) \cdot ( {y}_{4} - {y}_{3} )}{\sqrt{{( {x}_{2} - {x}_{1} )}^{2} + {( {y}_{2} - {y}_{1} )}^{2} \cdot } \sqrt{{( {x}_{4} - {x}_{3} )}^{2} + {( {y}_{4} - {y}_{3} )}^{2}}} ) \qquad ( 1 )$$

$${θ}_{leg} = {cos}^{- 1} ( \frac{( {x}_{3} - {x}_{2} ) \cdot ( {x}_{4} - {x}_{1} ) + ( {y}_{3} - {y}_{2} ) \cdot ( {y}_{4} - {y}_{1} )}{\sqrt{{( {x}_{3} - {x}_{2} )}^{2} + {( {y}_{3} - {y}_{2} )}^{2} \cdot } \sqrt{{( {x}_{4} - {x}_{1} )}^{2} + {( {y}_{4} - {y}_{1} )}^{2}}} ) \qquad ( 2 )$$

$$10 ° \leq {θ}_{hand} , {θ}_{leg} \leq 108 ° \qquad ( 3 )$$

The processor 110 may determine whether to generate a playback control command for playback speed control (e.g., fast forward, rewind, or slow motion) according to the expression of the target object 30 (e.g., the user). Specifically, the processor 110 may perform facial recognition on a face 35 of the target object 30 (e.g., the user) in the user image to obtain multiple joints, such as a joint 41 representing the left eye, a joint 42 representing the right eye, a joint 43 representing the left corner of the mouth, and a joint 44 representing the right corner of the mouth. The processor 110 may calculate an area change of a polygon 40 formed by multiple joints. If the time when an absolute value of the area change is greater than a change threshold is greater than a time threshold, it means that the target object 30 (e.g., the user) may be surprised or confused by the demonstration image. Accordingly, the processor 110 may generate a playback control command (e.g., a slow-motion command) for reducing the playback speed. If the absolute value of the area change is less than or equal to the change threshold, or the time when the absolute value of the area change is greater than the change threshold is less than or equal to the time threshold, the processor 110 may not generate a playback control command for playback speed control. The processor 110 may calculate an area Pt of the polygon 40 at time point t according to formula (4), and may calculate an area change AP of the polygon 40 during a period (t₂−t₁) according to formula (5), where (x₁, y₁) represents the coordinates of the joint 31, (x₂, y₂) represents the coordinates of the joint 32, (x₃, y₃) represents the coordinates of the joint 33, and (x₄, y₄) represents the coordinates of the joint 34.

$${P}_{t} = \frac{1}{2} \vert {x}_{1} {y}_{2} + {x}_{2} {y}_{3} + {x}_{3} {y}_{4} + {x}_{4} {y}_{1} - {x}_{2} {y}_{1} - {x}_{3} {y}_{2} - {x}_{4} {y}_{3} - {x}_{1} {y}_{4} \vert \qquad ( 4 )$$

$$Δ P = {P}_{t 2} - {P}_{t 1} \qquad ( 5 )$$

In an embodiment, the processor 110 may determine whether the face of the target object 30 (e.g., the user) is close to or far away from the playback device (e.g., the terminal device 300) that plays the demonstration image according to the area change ΔP of the polygon 40. If the area change ΔP is greater than the threshold, it means that the target object 30 (e.g., the user) may not be able to see the demonstration image clearly and the target object 30 (e.g., the user) has to move his/her face closer to the playback device. Accordingly, the processor 110 may generate a playback control command (e.g., a slow-motion command) for reducing the playback speed, so that the user can more easily see the details of the demonstration video. If the area change ΔP is less than or equal to the threshold, it means that the target object 30 (e.g., the user) can see the demonstration image clearly and therefore does not move his/her face closer to the playback device. Accordingly, the processor 110 may generate a playback control command for increasing (or resuming) the playback speed.

In an embodiment, the processor 110 may perform expression recognition on the face 35 of the target object 30 (e.g., the user) in the user image based on, for example, machine learning technology, and generate a playback control command for playback speed control (e.g., fast forward, rewind, or slow motion) according to a recognition result of the expression recognition. For example, if the recognition result of the expression recognition indicates that the user is confused, the processor 110 may generate a playback control command (e.g., a slow-motion command) for reducing the playback speed, so that the user can more easily see the details of the demonstration video.

Referring to FIG. 2, in an embodiment, after generating an adjustment command or a playback control command, the processor 110 may generate a script corresponding to the demonstration image. The script may include the adjustment command or the playback control command, and may include a timestamp corresponding to the adjustment command or the playback control command. The processor 110 may upload the script to the cloud server 500 for other users to download. For example, the terminal device 400 may download the script from the cloud server 500. The terminal device 400 may execute the script when playing the demonstration image to adjust the display region or playback mode of the demonstration image. Accordingly, the terminal device 400 may automatically adjust the playback of the demonstration image without data transmission with the electronic device 100.

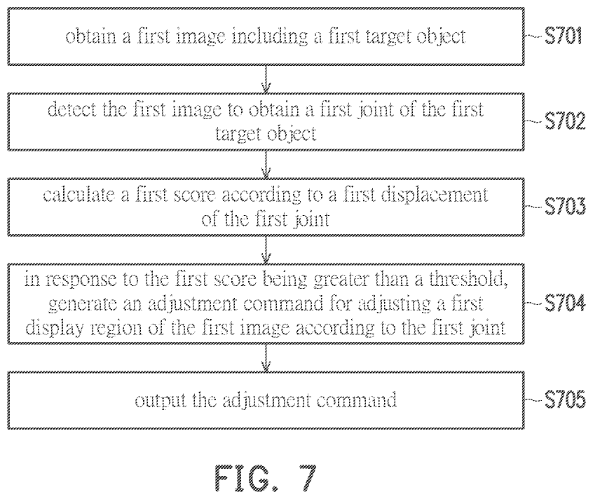

FIG. 7 illustrates a flow chart of a method for adjusting a display region based on motion according to an embodiment of the disclosure. The method can be implemented by the electronic device 100 shown in FIG. 1. In step S701, a first image including a first target object is obtained. In step S702, the first image is detected to obtain a first joint of the first target object. In step S703, a first score is calculated according to a first displacement of the first joint. In step S704, in response to the first score being greater than a threshold, an adjustment command for adjusting a first display region of the first image is generated according to the first joint. In step S705, the adjustment command is output.

To sum up, the electronic device of the disclosure may determine which region in the image is an important display region that the user pays attention to according to the motion of the person in the played image. The electronic device may further determine the important display region according to the audio of the image. After obtaining the important display region, the electronic device may output commands according to the important display region to adjust the playback method of the image played by the terminal device of the user. The disclosure provides the user with a convenient method of image playback, and the user does not need to manually operate the terminal device to change the display region of the image played by the terminal device.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic device for adjusting a display region based on motion, comprising:
a transceiver, obtaining a first image comprising a first target object; and
a processor, coupled to the transceiver, configured to:
detect the first image to obtain a first joint of the first target object;
calculate a first score according to a first displacement of the first joint;
in response to the first score being greater than a threshold, generate an adjustment command for adjusting a first display region of the first image according to the first joint; and
output the adjustment command through the transceiver.

2. The electronic device according to claim 1, wherein the processor is further configured to:
calculate a second score according to a second displacement of a second joint of the first target object; and
in response to the second score being greater than the threshold, generate the adjustment command according to the first joint and the second joint.

3. The electronic device according to claim 2, wherein the processor is further configured to:
divide a region of interest of the first image to obtain a plurality of sub-regions, wherein the sub-regions comprise a first sub-region and a second sub-region;
determine that the first joint is located in the first sub-region and the second joint is located in the second sub-region according to the first image; and
in response to the second sub-region being adjacent to the first sub-region, generate the adjustment command according to the first joint and the second joint.

4. The electronic device according to claim 3, wherein the sub-regions comprise a third sub-region corresponding to a third joint of the first target object, wherein a third score corresponding to the third joint is greater than the threshold, and the processor is further configured to:
in response to the first sub-region being adjacent to the second sub-region and the third sub-region being adjacent to at least one of the first sub-region and the second sub-region, generate the adjustment command according to the first joint, the second joint, and the third joint.

5. The electronic device according to claim 3, wherein the processor is further configured to:
generate the first display region according to at least one sub-region comprising the first sub-region; and
in response to the second sub-region not being adjacent to the at least one sub-region, generate a second display region of the first image according to the second sub-region.

6. The electronic device according to claim 5, wherein the adjustment command instructs that the first display region of the first image is output in a first period and the second display region of the first image is output in a second period.

7. The electronic device according to claim 6, wherein the processor is further configured to:
in response to a size of the second display region being different from a size of the first display region, generate the adjustment command comprising a zoom in operation or a zoom out operation.

8. The electronic device according to claim 3, wherein the processor is further configured to:
determine a boundary of the first display region according to a union of the first sub-region and the second sub-region.

9. The electronic device according to claim 1, wherein the processor is further configured to:
obtain a first audio file corresponding to the first image through the transceiver;
determine a first correlation between the first audio file and the first joint; and
calculate the first score according to the first displacement and the first correlation.

10. The electronic device according to claim 9, wherein the processor is further configured to:
perform a speech-to-text conversion on the first audio file to generate text;
determine a number of words in the text associated with the first joint; and
determine the first correlation according to the number of the words.

11. The electronic device according to claim 9, wherein the processor is further configured to:
determine a first weight of the first displacement and a second weight of the first correlation according to a category of the first image; and
calculate the first score according to the first displacement, the first weight, the first correlation, and the second weight.

12. The electronic device according to claim 1, wherein the processor is further configured to:
obtain a second image comprising a second target object according to the transceiver; and
generate a playback control command for the first image according to the second image, and output the playback control command through the transceiver.

13. The electronic device according to claim 12, wherein the processor is further configured to:
detect the second image to obtain a plurality of limb joints of the second target object, wherein the limb joints comprise a left elbow joint, a right elbow joint, a left knee joint, and a right knee joint;
calculate an angle according to the limb joints, and determine that the angle is within a default range; and
in response to the angle being outside the default range, generate the playback control command for pausing the first image.

14. The electronic device according to claim 1, wherein the processor is further configured to:
perform facial recognition on a second target object in a second image to obtain a plurality of joints;
calculate an area change of a polygon formed by the joints; and
in response to an absolute value of the area change being greater than a change threshold, generate a playback control command for playback speed control.

15. The electronic device according to claim 14, wherein the playback control command is used to reduce a playback speed of the first image.

16. The electronic device according to claim 1, wherein the processor is further configured to:
perform facial recognition on a second target object in a second image to obtain a plurality of joints;
calculate an area change of a polygon formed by the joints; and
generate a playback control command for playback speed control according to the area change.

17. The electronic device according to claim 16, wherein the processor is further configured to:
in response to the area change being greater than a first threshold, generate the playback control command for reducing a playback speed of the first image; and
in response to the area change being less than or equal to a second threshold, generate the playback control command for increasing the playback speed of the first image.

18. The electronic device according to claim 1, wherein the processor is further configured to:
detect the first image to obtain a center point and a height of the first target object; and
determine a region of interest of the first image according to the center point and the height.

19. The electronic device according to claim 1, wherein the processor is further configured to:
output a script through the transceiver, wherein the script comprises the adjustment command and a timestamp of the first image corresponding to the adjustment command.

20. A method for adjusting a display region based on motion, comprising:
obtaining a first image comprising a first target object;
detecting the first image to obtain a first joint of the first target object;
calculating a first score according to a first displacement of the first joint;
in response to the first score being greater than a threshold, generating an adjustment command for adjusting a first display region of the first image according to the first joint; and
outputting the adjustment command.
